(19) United States
(12) Patent Application Publication
(10) Pub. No.: US 2020/0361795 A1
(43) Pub. Date: Nov. 19, 2020

(54) Electrolytic Water Production Device and a Method of Producing Electrolytic Water

(71) Applicant: NIHON TRIM CO., LTD., Osaka-shi, Osaka (JP)

(72) Inventor: Daiji AMENOMORI, Nankoku-shi, Kochi (JP)

(21) Appl. No.: 16/493,099

(22) PCT Filed: Mar. 20, 2018
(86) PCT No.: PCT/JP2018/010917

§ 371 Date: Sep. 11, 2019

(30) Foreign Application Priority Data
Mar. 22, 2017 (JP) 2017-055892

(51) Int. Cl. C02F 1/461; C25B 1/10; C25B 9/04; C25B 9/08; C25B 15/08; C01B 3/00

(52) U.S. Cl. CPC C02F 1/4618; C25B 1/10; C25B 9/04; C25B 9/08; C02F 2201/4618; C01B 3/0026; C02F 2201/46115; C02F 2201/4613; C02F 2201/46145; C25B 15/08

(57) ABSTRACT

An electrolytic water production device 1 includes an electrolytic chamber 40 to which water to be electrolyzed is supplied, a first power feeder 41 and a second power feeder 42 arranged to face each other in the electrolytic chamber 40 and having different polarity, a membrane 43 arranged between the first power feeder 41 and the second power feeder 42 so as to divide the electrolytic chamber 40 into a first pole chamber (40a) positioned on a side of the first power feeder 41 and a second pole chamber (40b) positioned on a side of the second power feeder 42, and a control unit 5 for switching the polarity of the first power feeder 41 and the second power feeder 42 between anode and cathode, wherein surfaces of the first power feeder 41 and the second power feeder 42 are formed of a hydrogen storage metal, and the control unit 5 has an operation mode for switching the polarity each time electrolysis is started in the electrolytic chamber 40.

### TECHNICAL FIELD

The present invention relates to an electrolytic water production device and the like that produce electrolytic water containing hydrogen storage metal colloid.

### BACKGROUND ART

Conventionally, various researches and developments have been made on electrolytic water containing a colloidal hydrogen storage metal. Patent Literature 1 has proposed a technique of adding colloid to an aqueous electrolyte solution before electrolysis, for example.

### CITATION LIST

### Patent Literature

Patent Literature 1: Japanese Patent No. 3569270

However, since the above-mentioned technique involves the step of adding colloid to the aqueous electrolyte solution, the configuration of the electrolytic water production device may become complicated, and the handling of the device may become complicated, therefore, there is still room for improvement.

### SUMMARY OF THE INVENTION

### Problems to be Solved by the Invention

The present invention was made in view of the above, and a primary object thereof is to provide an electrolytic water production device capable of easily producing electrolytic water containing a large amount of hydrogen storage metal colloid with a simple configuration.

### Means for Solving the Problem

In a first aspect of the present invention, an electrolytic water production device includes an electrolytic chamber to which water to be electrolyzed is supplied, a first power feeder and a second power feeder arranged to face each other in the electrolytic chamber and having different polarity, a membrane arranged between the first power feeder and the second power feeder so as to divide the electrolytic chamber into a first pole chamber positioned on a side of the first power feeder and a second pole chamber positioned on a side of the second power feeder, and a polarity switching unit for switching the polarity of the first power feeder and the second power feeder between anode and cathode, wherein surfaces of the first power feeder and the second power feeder are formed of a hydrogen storage metal, and the polarity switching unit has an operation mode for switching the polarity each time electrolysis is started in the electrolytic chamber.

In the first aspect of the invention, it is preferred that the hydrogen storage metal is a metal containing platinum.

In the first aspect of the invention, it is preferred that the electrolytic water production device further includes an anode water pipe for taking out the electrolytic water produced in the pole chamber arranged on the anode side among the first pole chamber and the second pole chamber, a cathode water pipe for taking out the electrolytic water produced in the pole chamber arranged on the cathode side among the first pole chamber and the second pole chamber, and a flow path switching unit for switching the connection of the first pole chamber and the second pole chamber with the anode water pipe and the cathode water pipe.

In the first aspect of the invention, it is preferred that the electrolytic water production device further includes a water amount limiting unit for limiting an amount of water supplied to the pole chamber arranged on the anode side among the first pole chamber and the second pole chamber.

In the first aspect of the invention, it is preferred that the electrolytic water production device further includes a return water pipe for returning the water flowing out of the pole chamber arranged on the anode side among the first pole chamber and the second pole chamber to the pole chamber on the anode side.

In a second aspect of the invention, a method of producing electrolytic water by applying a voltage between a first power feeder and a second power feeder arranged to face each other in water includes a polarity switching step of switching polarity of the first power feeder and the second power feeder each time electrolysis is started.

### Advantageous Effects of the Invention

In the electrolytic water production device according to the first aspect of the present invention, since the surfaces of the first power feeder and the second power feeder are formed of the hydrogen storage metal, the hydrogen storage metal is ionized during electrolysis in the pole chamber arranged on the anode side. A part of hydrogen storage metal ions produced at this time remain in the pole chamber even after the end of the electrolysis. Then, when the next electrolysis is started, the polarity switching unit switches the polarity. Along with this, the power feeder which functioned as an anode to ionize the hydrogen storage metal functions as a cathode to supply electrons to the ions of the hydrogen storage metal. Thereby, the colloidal hydrogen storage metal precipitates in the pole chamber, therefore, electrolytic water containing a large amount of the hydrogen storage metal colloid is produced.

In the method of producing electrolytic water according to the second aspect of the present invention, by applying a voltage between the first power feeder and the second power feeder arranged to face each other in water, the hydrogen storage metal is ionized on the surface of the power feeder arranged on the anode side. A part of the hydrogen storage metal ions produced at this time adhere to the surface of the power feeder even after the end of the electrolysis. Then, when the next electrolysis is started, the polarity switching step is performed and the polarity of the first power feeder and the second power feeder is switched. Along with this, the power feeder to which the ions of the hydrogen storage metal are adhered functions as a cathode and supplies electrons to the ions of the hydrogen storage metal. Thereby, the colloidal hydrogen storage metal precipitates on the surface of the power feeder, therefore, electrolytic water containing a large amount of the hydrogen storage metal colloid is produced.

### BRIEF DESCRIPTION OF THE DRAWINGS

FIG. 1 A diagram showing a flow path configuration of the electrolytic water production device according to an embodiment of the present invention.

FIG. 2 A block diagram showing an electrical configuration of the electrolytic water production device of FIG. 1.

FIG. 3 A flowchart showing an embodiment of a process procedure of a control unit of FIG. 2.

FIG. 4 A diagram showing the flow path configuration of a modification of the electrolytic water production device of FIG. 1.

### DESCRIPTION OF THE PREFERRED EMBODIMENT

An embodiment of the present invention will now be described below in conjunction with accompanying drawings.

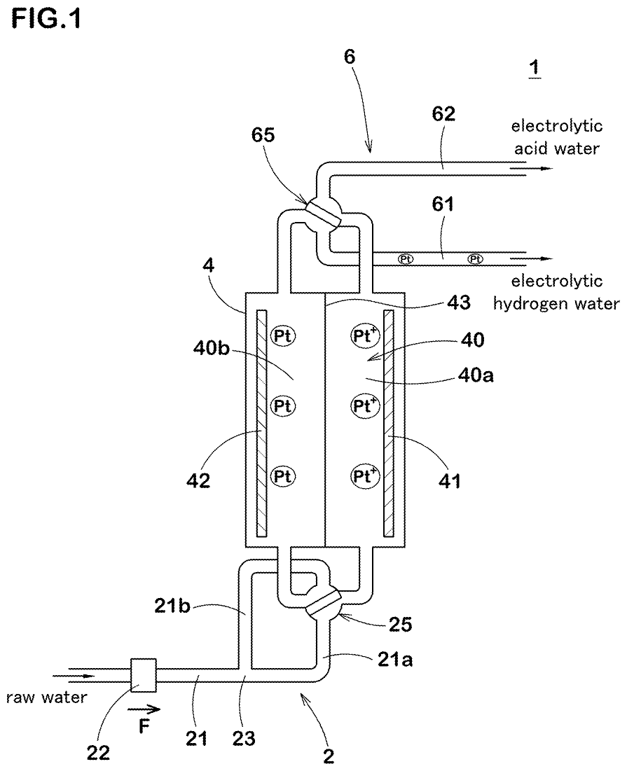

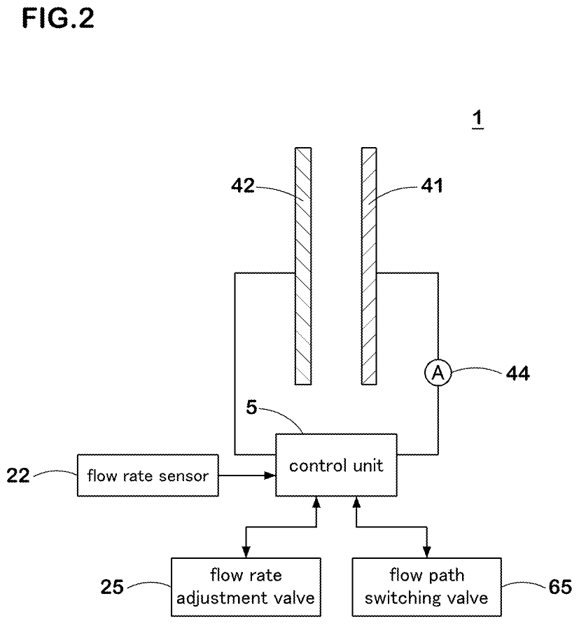

FIG. 1 shows a schematic configuration of an electrolytic water production device 1 according to the present embodiment. FIG. 2 shows an electrical configuration of the electrolytic water production device 1. The electrolytic water production device 1 is provided with an electrolytic chamber 40 to which water to be electrolyzed is supplied, a first power feeder 41 and a second power feeder 42 having different polarities, a membrane 43 dividing the electrolytic chamber 40, and a control unit 5 for controlling each part of the electrolytic water production device 1.

The electrolytic chamber 40 is formed inside an electrolytic cell 4. Raw water before electrolysis is supplied to the electrolytic chamber 40. Generally, tap water is used as the raw water, but in addition, well water, groundwater, etc. can be used, for example. A water purification cartridge for purifying water supplied to the electrolytic chamber 40 may be provided on the upstream side of the electrolytic chamber 40.

The first power feeder 41 and the second power feeder 42 are arranged to face each other in the electrolytic chamber 40. Surfaces of the first power feeder 41 and the second power feeder 42 are formed of the hydrogen storage metal. The hydrogen storage metal is, for example, platinum, palladium, vanadium, magnesium, zirconium, and alloys containing these as components. In this embodiment, a platinum plating layer is formed on the surfaces of the first power feeder 41 and the second power feeder 42.

The membrane 43 is disposed between the first power feeder 41 and the second power feeder 42. The membrane 43 divides the electrolytic chamber 40 into a first pole chamber (40a) positioned on a side of the first power feeder 41 and a second pole chamber (40b) positioned on a side of the second power feeder 42. The membrane 43 is made of a polytetrafluoroethylene (PTFE) hydrophilic film, for example. When a DC voltage is applied between the first power feeder 41 and the second power feeder 42, the water is electrolyzed in the electrolytic chamber 40 to obtain electrolytic water.

For example, in the state shown in FIG. 1, the first power feeder 41 is positively charged, and the first pole chamber (40a) functions as an anode chamber. on the other hand, the second power feeder 42 is negatively charged, and the second pole chamber (40b) functions as a cathode chamber. Thereby, in the second pole chamber (40b), reductive electrolytic hydrogen water in which the generated hydrogen gas is dissolved is produced, and in the first pole chamber (40a), the electrolytic acid water in which the generated oxygen gas is dissolved is produced.

As shown in FIG. 2, the first power feeder 41 and the second power feeder 42 and the control unit 5 are connected via a current supply line. A current detection unit 44 is provided in the current supply line between the first power feeder 41 and the control unit 5. The current detection unit 44 may be provided in the current supply line between the second power feeder 42 and the control unit 5. The current detection unit 44 detects a direct current (electrolytic current) supplied to the first power feeder 41 and the second power feeder 42, and outputs an electrical signal corresponding to the detected value to the control unit 5.

The control unit 5 includes a central processing unit (CPU) that executes various types of arithmetic processing, information processing, and the like, a program that controls the operation of the CPU, a memory that stores various information, and the like, for example. Various functions of the control unit 5 are realized by the CPU, the memory, and the program.

The control unit 5 controls a DC voltage (electrolytic voltage) applied to the first power feeder 41 and the second power feeder 42 based on the electrical signal output from the current detection unit 44, for example. More specifically, the control unit 5 performs feedback control of the voltage applied to the first power feeder 41 and the second power feeder 42 so that the electrolytic current detected by the current detection unit 44 becomes a desired value according to the dissolved hydrogen concentration inputted by the user and the like. For example, when the electrolytic current is too high, the control unit 5 decreases the voltage, and when the electrolytic current is too low, the control unit 5 increases the voltage. Thereby, the electrolytic current supplied to the first power feeder 41 and the second power feeder 42 is appropriately controlled, therefore, hydrogen water having a desired dissolved hydrogen concentration is produced in the electrolytic chamber 40.

The polarity of the first power feeder 41 and the second power feeder 42 is controlled by the control unit 5. That is, the control unit 5 functions as a polarity switching unit for switching the polarity of the first power feeder 41 and the second power feeder 42. By appropriately switching the polarity of the first power feeder 41 and the second power feeder 42, the control unit 5 equalizes the opportunity for the first power feeder 41 and the second power feeder 42 to function as the anode chamber or the cathode chamber. Thereby, adhesion of scales to the first power feeder 41 and the second power feeder and the like is suppressed. Hereinafter, in this specification, unless otherwise specified, the case where the first power feeder 41 functions as the anode feeder and the second power feeder 42 functions as the cathode feeder will be described.

As shown in FIG. 1, the electrolytic water production device 1 further includes a water inlet portion 2 provided on the upstream side of the electrolytic cell 4 and a water outlet portion 6 provided on the downstream side of the electrolytic cell 4.

The water inlet portion 2 has a water supply pipe 21, a flow rate sensor 22, a branch portion 23, a flow rate adjustment valve 25, and the like. The water supply pipe 21 supplies water to be electrolyzed to the electrolytic chamber 40. The flow rate sensor 22 is provided in the water supply pipe 21. The flow rate sensor 22 periodically detects the flow rate (F) per unit time (hereinafter, may be simply referred to as “flow rate”) of water supplied to the electrolytic chamber 40, and outputs a signal corresponding to the detected value to the control unit 5.

The branch portion 23 branches the water supply pipe 21 to two directions of water supply pipes (21a) and (21b). The flow rate adjustment valve 25 connects the water supply pipes 21a and 21b with the first pole chamber (40a) or the second pole chamber (40b). The flow rate of water supplied to the first pole chamber (40a) and the second pole chamber (40b) is adjusted by the flow rate adjustment valve 25 under the control of the control unit 5. In this embodiment, since the flow rate sensor 22 is provided on the upstream side of the branch portion 23, the sum of the flow rate of the water supplied to the first pole chamber (40a) and the flow rate of the water supplied to the second pole chamber (40b), that is, the flow rate (F) of the water supplied to the electrolytic chamber 40 is detected.

The water outlet portion 6 has a first water outlet pipe 61, a second water outlet pipe 62, and a flow path switching valve 65.

In FIG. 1, the first water outlet pipe 61 functions as a cathode water pipe for taking out the electrolytic water produced in the pole chamber on the cathode side of the first pole chamber (40a) and the second pole chamber (40b) (that is, the electrolytic hydrogen water). on the other hand, the second water outlet pipe 62 functions as an anode water pipe for taking out the electrolytic water produced in the pole chamber on the anode side of the first pole chamber (40a) and the second pole chamber (40b).

The flow path switching valve 65 is provided downstream of the electrolytic cell 4. The flow path switching valve 65 functions as a flow path switching unit for switching the connection of the first pole chamber (40a) and the second pole chamber (40b) with the first water outlet pipe 61 and the second water outlet pipe 62.

In this embodiment, the control unit 5 synchronizes the switching of the polarity of the first power feeder 41 and the second power feeder 42 with the switching of the flow path by the flow path switching valve 65 so that the electrolytic water selected by the user (for example, In FIG. 1, the electrolytic hydrogen water) can always be discharged from the same one of the water pipes (in FIG. 1, the first water outlet pipe 61).

In switching the polarity of the first power feeder 41 and the second power feeder 42, it is preferred that the control unit 5 operates the flow rate adjustment valve 25 and the flow path switching valve 65 in conjunction with each other. Thereby, before and after the switching of the polarity, the water supply to the pole chamber connected to the first water outlet pipe 61 is sufficiently secured, while the water supply to the pole chamber connected to the second water outlet pipe 62 is suppressed, therefore, it is possible to make effective use of water.

It is preferred that the flow rate adjustment valve 25 and the flow path switching valve 65 are integrally formed and driven by a single motor in conjunction with each other as described in Japanese Patent Publication No. 5809208, for example. That is, the flow rate adjustment valve 25 and the flow path switching valve 65 are constituted by a cylindrical outer cylinder, a cylindrical inner cylinder, and the like. Inside and outside of the inner cylinder, flow paths forming the flow rate adjustment valve 25 and the flow path switching valve 65 are provided, and each flow path is configured so as to cross as appropriate according to the operating state of the flow rate adjustment valve 25 and the flow path switching valve 65. The valve device configured as such is referred to as a “double automatic change cross line valve”, and contributes to simplifying the configuration and control of the electrolytic water production device 1, therefore, the commercial value of the electrolytic water production device 1 is further increased.

The control unit 5 controls the polarity of the first power feeder 41 and the second power feeder 42 in a plurality of “operation modes”. The above operation modes include a “colloidal water mode” suitable for producing electrolytic water containing a large amount of hydrogen storage metal colloid, for example.

In the colloidal water mode, the control unit 5 switches the polarity each time the electrolytic chamber 40 starts electrolysis. That is, in performing the electrolysis in the electrolytic chamber 40, the polarity of the first power feeder 41 and the second power feeder 42 are switched each time. In the operation mode other than the colloidal water mode, the polarity of the first power feeder 41 and the second power feeder 42 are switched every predetermined number of times of electrolysis is started, that is, after the electrolysis is performed a plurality of times.

As already described above, since the surfaces of the first power feeder 41 and the second power feeder 42 are formed of the hydrogen storage metal, the hydrogen storage metal is ionized during electrolysis in the pole chamber arranged on the anode side (in FIG. 1, the first pole chamber (40a), for example). A part of the hydrogen storage metal ions (in this embodiment, platinum ions) produced at this time remain in the first pole chamber (40a) even after the end of the electrolysis and adhere to the surface of the power feeder.

Then, when the next electrolysis is started in the colloidal water mode, the control unit 5 switches the polarity of the first power feeder 41 and the second power feeder 42, therefore, the first power feeder 41 arranged in the first pole chamber (40a) where the ions of the hydrogen storage metal exist functions as the cathode and attracts the ions of the hydrogen storage metal to supply electrons. Along with this, the colloidal hydrogen storage metal precipitates in the first pole chamber (40a), therefore, electrolytic water containing a large amount of minute hydrogen storage metal colloid (platinum nano-colloid in this embodiment) having a diameter of nanometer level is produced.

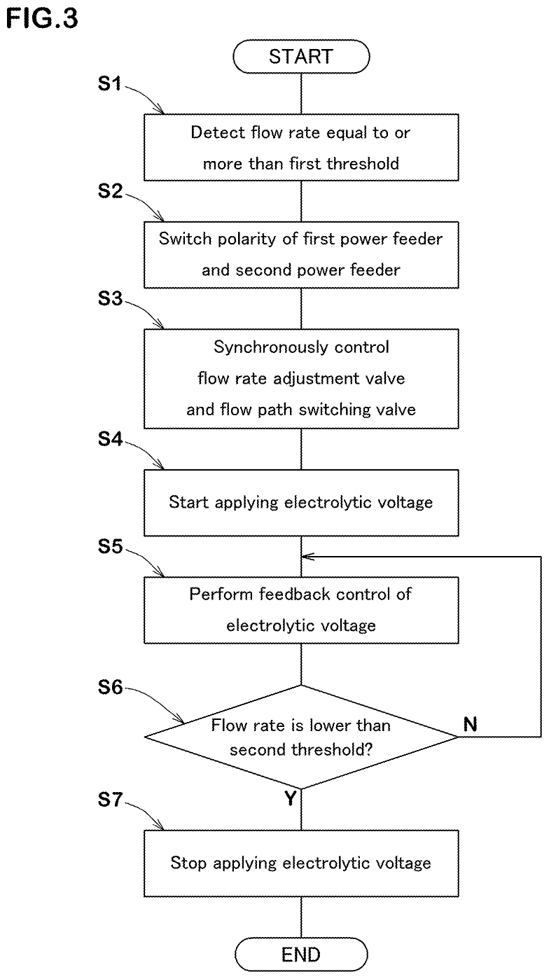

FIG. 3 is a flow chart showing an embodiment of the processing procedure of the control unit 5 operating in the colloidal water mode. First, when the flow rate sensor 22 detects a flow rate equal to or more than a predetermined first threshold (step S1), the control unit 5 determines that the faucet with which the water supply pipe 21 is connected has been opened by the user. And the control unit 5 switches the polarity of the first power feeder 41 and the second power feeder 42 (step S2) and synchronously controls the flow rate adjustment valve 25 and the flow path switching valve 65 (step s3), and then applies the electrolysis voltage to the first power feeder 41 and the second power feeder 42 to start the electrolysis (Step s4). The processes of the Steps S2 and S3 may be performed simultaneously or in reverse order.

Further, the control unit 5 feedback controls the electrolytic voltage applied to the first power feeder 41 and the second power feeder 42 so that the current detected by the current detection unit 44 becomes the desired value (step s5), and when the flow rate detected by the flow rate sensor 22 becomes lower than a predetermined second threshold (YES in step s6), the control unit 5 stops the application of the electrolytic voltage to the first power feeder 41 and the second power feeder 42 (step s7).

In the above step s2, the flow rate adjustment valve 25 limits the amount of water supplied to the pole chamber on the anode side. That is, in the electrolytic water production device 1, the flow rate adjustment valve 25 functions as a water amount limiting unit for limiting the amount of water supplied to the pole chamber on the anode side. By limiting the amount of water supplied to the pole chamber on the anode side by the flow rate adjustment valve 25, the concentration of the hydrogen storage metal ions in the electrolytic water in the pole chamber on the anode side is increased in the steps s4 to s7. Thereby, in the next electrolysis, the electrolytic water containing a large amount of the hydrogen storage metal colloid can be easily produced.

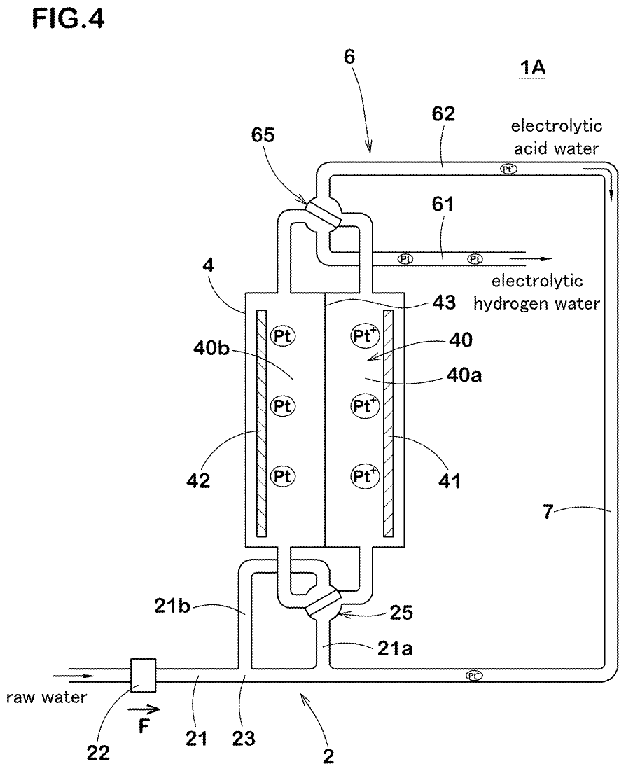

FIG. 4 shows an electrolytic water production device (1A), which is a modification of the electrolytic water production device 1 shown in FIG. 1. The configuration of the above-mentioned electrolytic water production device 1 can be adopted for portions of the electrolytic water production device (1A) which are not described below.

The electrolytic water production device (1A) further includes a return water pipe 7 which connects the water supply pipe (21a) with the pipe functioning as the anode water pipe among the first water outlet pipe 61 and the second water outlet pipe 62 (the second water outlet pipe 62 in FIG. 4). The water flowing out of the pole chamber on the anode side among the first pole chamber (40a) and the second pole chamber (40b) returns to the pole chamber on the anode side via the flow path switching valve 65, the anode water pipe, the return water pipe 7, the water supply pipe (21a), and the flow rate adjustment valve 25. Thereby, the hydrogen storage metal ions produced in the pole chamber on the anode side returns to the pole chamber on the anode side after circulating through the flow path switching valve 65, the anode water pipe, the return water pipe 7, the water supply pipe (21a), and the flow rate adjustment valve 25. Therefore, in the steps s4 to s7 shown in FIG. 3, the concentration of the hydrogen storage metal ions in the electrolytic water in the pole chamber on the anode side is increased. Thereby, in the next electrolysis, the electrolytic water containing a large amount of the hydrogen storage metal colloid can be easily produced.

While detailed description has been made of the electrolytic water production device 1 according to an embodiment of the present invention, the present invention can be embodied in various forms without being limited to the illustrated embodiment. That is, it suffices as long as the electrolytic water production device 1 is configured such that it at least includes the electrolytic chamber 40 to which water to be electrolyzed is supplied, the first power feeder 41 and the second power feeder 42 arranged to face each other in the electrolytic chamber 40 and having different polarity, the membrane 43 arranged between the first power feeder 41 and the second power feeder 42 so as to divide the electrolytic chamber 40 into the first pole chamber (40a) positioned on a side of the first power feeder 41 and the second pole chamber (40b) positioned on a side of the second power feeder 42, and the control unit 5 for switching the polarity of the first power feeder 41 and the second power feeder 42 between anode and cathode, wherein the surfaces of the first power feeder 41 and the second power feeder 42 are formed of a hydrogen storage metal, and the control unit 5 has the operation mode for switching the polarity each time electrolysis is started in the electrolytic chamber 40.

### DESCRIPTION OF THE REFERENCE SIGNS

1: electrolytic water production device
1A: electrolytic water production device
5: control unit (polarity switching unit)
7: return water pipe
25: flow rate adjustment valve (water amount limiting unit)
40: electrolytic chamber
40a: first pole chamber
40b: second pole chamber
41: first power feeder
42: second power feeder
43: membrane
65: flow path switching valve (flow path switching unit)

1. An electrolytic water production device comprising
an electrolytic chamber to which water to be electrolyzed is supplied,
a first power feeder and a second power feeder arranged to face each other in the electrolytic chamber and having different polarity,
a membrane arranged between the first power feeder and the second power feeder so as to divide the electrolytic chamber into a first pole chamber positioned on a side of the first power feeder and a second pole chamber positioned on a side of the second power feeder, and
a polarity switching unit for switching the polarity of the first power feeder and the second power feeder between anode and cathode, wherein
surfaces of the first power feeder and the second power feeder are formed of a hydrogen storage metal, and
the polarity switching unit has an operation mode for switching the polarity each time electrolysis is started in the electrolytic chamber.

2. The electrolytic water production device according to claim 1, wherein
the hydrogen storage metal is a metal containing platinum.

3. The electrolytic water production device according to claim 1 further comprising
an anode water pipe for taking out the electrolytic water produced in the pole chamber arranged on the anode side among the first pole chamber and the second pole chamber,
a cathode water pipe for taking out the electrolytic water produced in the pole chamber arranged on the cathode side among the first pole chamber and the second pole chamber, and
a flow path switching unit for switching the connection of the first pole chamber and the second pole chamber with the anode water pipe and the cathode water pipe.

4. The electrolytic water production device according to claim 1 further comprising
a water amount limiting unit for limiting an amount of water supplied to the pole chamber arranged on the anode side among the first pole chamber and the second pole chamber.

5. The electrolytic water production device according to claim 1 further comprising
a return water pipe for returning the water flowing out of the pole chamber arranged on the anode side among the first pole chamber and the second pole chamber to the pole chamber on the anode side.

6. A method of producing electrolytic water by applying a voltage between a first power feeder and a second power feeder arranged to face each other in water including
a polarity switching step of switching polarity of the first power feeder and the second power feeder each time electrolysis is started.
